(19) United States
(12) Patent Application Publication
(10) Pub. No.: US 2011/0185751 A1
(43) Pub. Date: Aug. 4, 2011

(54) Hybrid air conditioning system

(76) Inventors: William S. Carson, Lake Wales, FL (US); Sylvia H. Carson, Lake Wales, FL (US)

(21) Appl. No.: 12/929,295

(22) Filed: Jan. 12, 2011

Related U.S. Application Data
(60) Provisional application No. 61/336,090, filed on Jan. 19, 2010.

(51) Int. Cl. F24F 3/14; G05D 22/02; F25D 17/04

(52) U.S. Cl. 62/93; 236/44 C

(57) ABSTRACT

A hybrid air system is provided for conditioning the air in a building and includes first and second independent air conditioning systems, one system having a larger capacity than the other and an independent dehumidifier each work independently and together to control the air on the inside of a building. The hybrid system improves air comfort while increasing efficiency and reducing operating costs and use of energy.

This application claims the benefit of U.S. Provisional Application No. 61/336,090, filed Jan. 19, 2010.

### BACKGROUND OF THE INVENTION

The present invention relates to the treatment of air for the inside of a building and especially to a hybrid air conditioning system for the regulation of the air temperature and humidity utilizing independently operative air conditioning units of differing capacity and an independently. operative dehumidifier to control indoor air quality.

The present invention is in the technical fields of equipment and controls for performing inside air comfort and air quality treatments of inside air. The conventional “central air conditioning system”, is generally a single unit of a fixed or restricted capacity, sized as the largest machine required to cool down a buildings interior air on the hottest of days with the highest of heat loads, within a relatively short time period. This high level of capacity and power use is typically only needed for approximately one-third of the year, meaning that the equipment is over-sized and using more energy than needed to condition interior air for the remaining two-thirds of the year, resulting in problems such as wasting energy by over cooling and “reheats” to control humidity within a building structure. Inside air treatment needs to shift during the “off-season” two-thirds period, from the priority function of high heat control by the central air conditioner, to that of a need for smaller cooling capacities or for alternate air treatment needs such as control of humidity levels. In these situations, smaller cooling capacity equipment (such as a window unit) or a unit dedicated to a specific function such as humidity control provides superior inside air treatment at significantly lower energy use and costs to the consumer.

### SUMMARY OF THE INVENTION

The present invention is a new “hybrid” central air conditioning system that incorporates multiple air treatment devices operated by a process controller reacting to sensors, that matches specific air treatment machines to varying air treatment needs—such as humidity control—to maximize air conditioning performance while minimizing energy use.

A hybrid system is provided for conditioning the air in a building and includes first and second independent air conditioning systems, one system having an equal or larger capacity than the other and an independent dehumidifier, each working independently or together to control the air on the inside of a building.

The larger capacity air conditioner has a intake or return air duct and an outlet or supply air duct for drawing air from the inside of a building, through the air conditioner and back into the building. The smaller capacity air conditioner has an intake or return air duct leading from the larger capacity air conditioner intake duct to the smaller capacity air conditioner and back into the larger capacity air conditioner's out let air duct. The dehumidifier has an intake air duct leading from the larger capacity air conditioner intake duct to the dehumidifier and back into the larger capacity air conditioner's outlet air duct. The larger capacity air conditioner and the smaller capacity air conditioner and the dehumidifier each have a gate or valve located in their respective ducts which are opened only when the specific unit operational and closed when the unit is not operational. A building sensor senses the temperature and humidity within a building and is connected to a controller which controls the operation of the larger capacity air conditioner, smaller capacity air conditioner and dehumidifier to control the air temperature and humidity in the building. Each unit operates independently and can run singly or in combination with each other to control the comfort of the air in a building with increased efficiency over a single larger capacity, dedicated air conditioner which is directed to air cooling rather than moisture removal as with a dedicated dehumidifier.

### BRIEF DESCRIPTION OF THE DRAWINGS

FIG. 1 is a block diagram of a hybrid air conditioning system in accordance with the present invention;

FIG. 2 is a usage and energy table of a standard 3 ton air conditioning system; and

FIG. 3 is a usage and energy table using the present invention.

### DETAILED DESCRIPTION OF THE PREFERRED EMBODIMENT

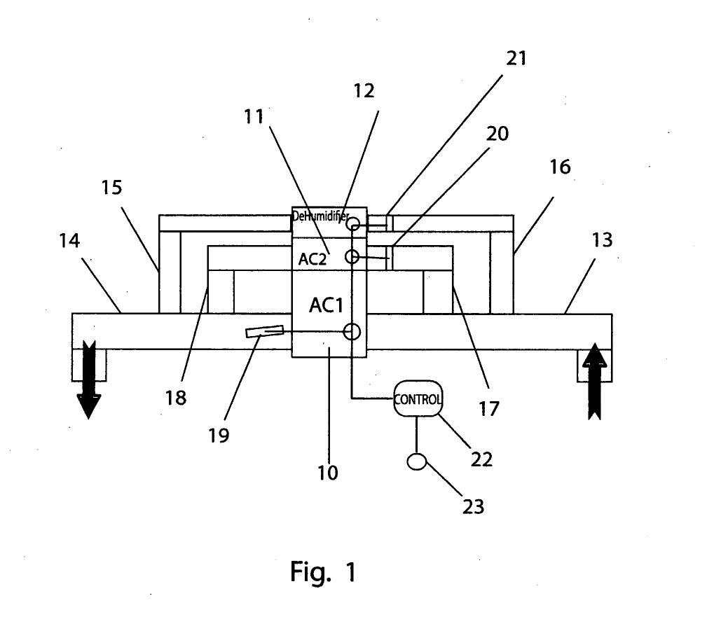

Referring now to the invention in more detail, in FIG. 1, a schematic view of the present hybrid air conditioning system, having a first or principal central air conditioner unit, 10, which includes a typical air conditioner or heat pump heat exchanger coil and air handler unit having a fan therein contained within said unit. The air conditioner 10 is connected to a building intake air duct 13 for drawing a building's inside air thereinto and having an outlet air duct 14 for delivering the conditioned output air therefrom. The duct 14 delivers conditioned air back into the interior space of a building. The use of air conditioner herein includes the use of a reverse cycle air conditioner or heat pump. The first conventional central air conditioner unit 10, has an operative open and close valve 19 (shown open) in the outlet air duct 14.

A self-contained second or auxiliary air conditioner or heat pump unit 11, has smaller capacity that the principal air conditioner unit 10, and has an auxiliary intake air supply or return air duct 17 connecting to the air conditioner 10 intake air supply duct 13. The auxiliary duct 17 has an open and close gate or valve 20 (shown closed), and also has an auxiliary outlet or supply air duct 18 connecting to the air conditioner outlet air duct 14 for supply auxiliary conditioned air thereinto. The auxiliary air conditioner or heat pump unit 11 with valve 20 in an open position can be operated to draw building interior supply air from the air conditioner duct 13, condition the air if needed, and supply the conditioned air to the interior of a building through the air conditioner outlet air duct 14, either singularly or in, combination with the air flow from air conditioner 10.

The hybrid system of the present invention has a self-contained and independently operated dehumidifier unit 12, which dehumidifier has an auxiliary intake or return air duct 16 connecting to the air conditioner unit return duct 13, with the intake or supply air duct 13. An open and close valve 21 (shown closed) is mounted therein. An auxiliary supply air outlet duct 15 is connected from the dehumidifier 12 to the air conditioner supply air outlet duct 14. The dehumidifier unit 12 and valve 21, are operated to draw building interior supply air from the air conditioner duct 13, condition it in air conditioner 12 and supply the conditioned dehumidifier air to the interior of a building through the air conditioner outlet supply air duct 14. The added dehumidifier unit 12, can be selectively operated as a stand alone unit to supply dehumidified air to a building, or in combination with the first air conditioner unit 10, or the second unit 11, or with both.

In operation the principal air conditioner unit 10 along with the open or close duct valve 19 is operated to open or close the flow of air through the air conditioner 10 while the auxiliary or second air conditioner unit 11 along with the open and close valve 20 is operated to open or close the flow of air through the auxiliary air conditioner 11. The dehumidifier 12 along with the open and close valve 21 is operated to open or close the flow of air to the dehumidifier 12. A process controller or CPU 22 receives inside air condition from sensors 23, which includes sensors for temperature and humidity, to compare with the temperature and humidity comfort levels desired and set by building owner, operators, or occupants, in order to selectively activate any of the air conditioner units 10 and 11 and the dehumidifier 12 and their respective duct valves 19, 20, and 21, to operate any of the unit separately or in any combination of units as directed by the controller 22 depending upon the sensed temperature and humidity in order to provide optimal comfort conditions inside the building with the lowest energy input and costs plus enhanced comfort and health benefits by matching the specific comfort conditioning air treatment needed or desired by the selecting equipment with the lowest power load.

A conventional central air conditioning system installation is generally the largest machine needed to cool down a buildings interior air, on the hottest of days with the highest of heat loads, within the relatively short time period necessary to achieve acceptable comfort. This high level of air conditioning power use, however, is typically only needed for about one-third of the year, meaning that the equipment is over-sized and uses more energy than needed to obtain comfort conditioned interior air for the remaining two-thirds of the year. In addition, the air comfort and air quality treatment needs shift from the primary function of heat control by the central air conditioner in summer months, to that of controlling other factors such as humidity when air temperatures are moderate or mild during fall and spring periods but humidity levels can build up because the cooling function of the air conditioner is not being activated for direct cooling (salient heat removal) of the interior air so as to also indirectly remove water vapor by condensation (latent heat removal) to lower the humidity. The invention herein described detects the increase in humidity level, and activates the dedicated dehumidifier unit 12, to dehumidify the air without running the central air conditioner, which would also lower the air temperature, often to a level where a “reheat” function is needed to raise the air temperature back up to the set comfort level, wasting energy.

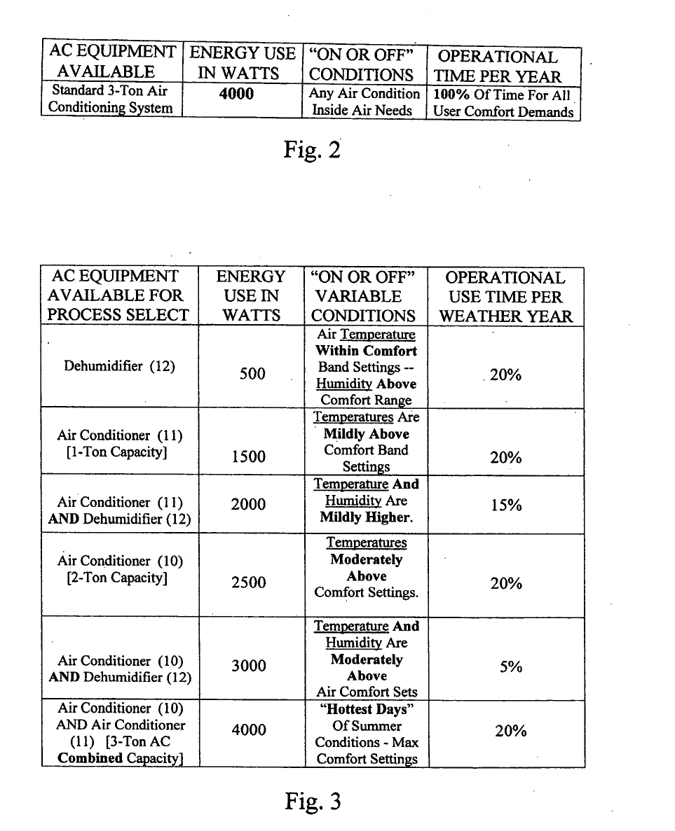

FIGS. 2 and 3 are tabular illustrations of a use of the invention to achieve energy savings. The table in FIG. 2 shows a typical central air conditioning system, which is generally of a maximum cooling capacity size for a building and in either in “on” or “off” state for all inside air comfort conditioning demands FIG. 3 shows how the present hybrid air conditioning system with an integrated equipment package and process control thereof, selectively matches the inside air comfort needs to an optimum energy-saving combination of dedicated equipment capacities and treatment choice options needed to more efficiently achieve the desired results. In FIG. 2 a building installation uses 100% of 4000 watt power for “on” conditioning use demands year around while in FIG. 3 the power is reduced by approximately 80% down to 20% (data cell lower right) by limiting use of the equipment 10 to just the highest demand periods for which it was selected and installed, and to instead use the invention to process-operate equipment 12, which is now selectively available to use less energy. The self-contained first air conditioner unit 10, and the second self contained air conditioner unit 11, and the self contained dehumidifier unit 12, can connect and combine together for greater efficiency. Units 10, 11, and 12 have certain elements and common functions of the individual units, such as electrical hookups and water condensate drain outlets which elements can be combined in the hybrid air conditioning system of the present invention using shared connections. Additionally, the air conditioning units 10 and 11 and the dehumidifier 12 do not have to be combined together into one modular unit, but can be located separately as long as the air flow ducts as shown are connected. The invention system and process controller can also be expanded and programmed for other air conditioning needs such as humidification in heating climates, or air cleaning devices, or for ventilation. The processing control can also control other energy consuming devices such as for timing a water heater cycle, if desired. The process control, sensors, and equipment can be wired or wireless and can incorporate the standard thermostat control into one user interface, and the process controller can be accessed, programmed, and controlled remotely via internet, phone line, power lines, or wireless connections, without limitation.

The present invention saves air conditioning operational energy and costs and delivers increased comfort and air quality, by the selective matching of the specific air conditioning treatments needed or desired, to the expanded range of invention equipment now available and offers varying power requirements and air treatment capabilities, that are now automatically available as alternatives to the sole use of a conventional size air conditioning unit.

The present invention also provides utility power suppliers with an interface to reduce air conditioning energy consumption during peak periods and offers customers reduced rates for off-peak use. It also provides users with air conditioning backup in case of a failure of a single unit, such as failure of air conditioners 10 or 11, and provides longer life with fewer repairs on equipment by spreading the operational uses to the best alternative equipment choices at the time.

In the broad embodiment, the present invention is a new type of air conditioning system for automatically achieving higher efficiency and comfort, using the new process control for selective use of the dedicated air conditioning equipment of varying size and treatment capabilities, based on sensor derived air conditions compared to specified user comfort setting needs that can save energy and costs by selectively specifying the optimum mix of equipment needed to meet a specific building and user with the least use of energy.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples which are to be considered illustrative rather restrictive.

We claim:

1. An apparatus for conditioning the air in a building comprising:
a first air conditioning system of predetermined capacity;
a intake air duct operatively connected to said first air conditioning system to direct return air thereinto;
an outlet air duct operatively connected to said first air conditioning system to direct conditioned air therefrom into the inside of a building;
a second air conditioning system having an equal or smaller capacity than said first air conditioning system and having an auxiliary intake air duct connected from said intake air duct into said second air conditioning system and an auxiliary outlet duct connected from said second air conditioning system into said outlet air duct;
a dehumidifier having an auxiliary intake duct connected from said intake air duct to said dehumidifier and an auxiliary outlet duct connected from said dehumidifier to said outlet air duct;
building sensor for sensing temperature and humidity within a building; and
control means for controlling the operation of said first and second air conditioning systems and said dehumidifier, said control means being operatively connected to said building sensor;
whereby a hybrid air conditioning system controls the air temperature and humidity in a structure with increased efficiency.

2. The apparatus for conditioning the air in a building in accordance with claim 1 in which said first air conditioner has a duct valve for closing the air flow through the first air conditioner when the first air conditioner is not operative.

3. The apparatus for conditioning the air in a building in accordance with claim 2 in which said second air conditioner has a duct valve for closing the air flow through said second air conditioner when said second air conditioner is not operative.

4. The apparatus for conditioning the air in a building in accordance with claim 3 in which said dehumidifier has a duct valve for closing the air flow through dehumidifier when said dehumidifier is not operative.

5. The apparatus for conditioning the air in a building in accordance with claim 4 in which said first air conditioner duct valve is positioned in said first air conditioner outlet air duct for closing the air flow through the first air conditioner when the first air conditioner is not operative.

6. The apparatus for conditioning the air in a building in accordance with claim 5 in which said second air conditioner duct valve is positioned in said second air conditioner intake air duct for closing the air flow through the second air conditioner when the second air conditioner is not operative.

7. The apparatus for conditioning the air in a building in accordance with claim 6 in which said dehumidifier duct valve is positioned in said dehumidifier intake air duct for closing the air flow through the dehumidifier when the dehumidifier is not operative.

8. An apparatus for conditioning the air in a building comprising:
first and second independent air conditioning systems, one system being equal or of larger capacity than the other;
a dehumidifier;
intake and outlet air ducts operatively connected to said first air conditioning system to direct return air thereinto and conditioned air therefrom;
intake and outlet air ducts operatively connected through said second air conditioning system from said first air conditioner intake air duct through said second air condition system and into said first air conditioner outlet air duct;
intake and outlet air ducts operatively connected through said dehumidifier from said first air conditioner intake air duct through said dehumidifier and into said first air conditioner outlet air duct;
building sensor for sensing temperature and humidity within a building; and
control means for controlling the operation of said first and second air conditioning systems and said dehumidifier, said control means being operatively connected to said building sensor;
whereby a hybrid air conditioning system controls the air temperature and humidity in a structure with increased efficiency.

9. A process for treating the inside air of a building comprising the steps of:
selecting an air treatment system for a building having a first air conditioning system of predetermined capacity having inlet and outlet air ducts and having a second air conditioning system having an equal or smaller capacity than said first air conditioning system and having an auxiliary intake air duct connected to said first air conditioning intake duct and an auxiliary outlet air duct connected to said first air conditioning system outlet duct and having a dehumidifier having an auxiliary intake duct connected to said first air conditioner intake air duct and an auxiliary outlet duct connected said first air conditioner outlet air duct;
sensing the temperature and humidity within the building;
activating said selected air treatment system first and second air conditioning units and said dehumidifier selectively responsive to the sensed temperature and humidity within the building whereby said first and second air conditioning systems and said dehumidifier may be operated separately or in any combination with each other;
whereby the air inside a building may be controlled with increased efficiency over a conventional dedicated air conditioning system.

10. A process for treating the inside air of a building in accordance with claim 9 in which the step of selecting an air treatment system includes selecting said first air conditioning system and said second air conditioning system and said dehumidifier each with an air flow valve located in the respective ducts thereof.
